(19) United States
(12) Patent Application Publication
(10) Pub. No.: US 2024/0009760 A1
(43) Pub. Date: Jan. 11, 2024

(54) PROCESSING DEVICE AND METHOD

(71) Applicant: 4JET microtech GmbH, Alsdorf (DE)

(72) Inventor: Dennis VÖLL, Nideggen (DE)

(21) Appl. No.: 18/348,220

(22) Filed: Jul. 6, 2023

(30) Foreign Application Priority Data
Jul. 6, 2022 (DE) 10 2022 116 899.9

(51) Int. Cl. B23K 26/03

(52) U.S. Cl. CPC B23K 26/03

(57) ABSTRACT

Disclosed is a method comprising: processing a workpiece in a processing position and thereby generating a marking in the processing position, the processing position being defined by coordinates in a processing coordinate system; determining a measuring position of the marking in a measuring coordinate system by measuring the marking; defining a mapping using the processing position and the measuring position, wherein the mapping maps a position in the measuring coordinate system onto a position in the processing coordinate system.

This application claims priority to German Patent Application No. 10 2022 116 899.9 filed 6 Jul. 2022, the disclosure of which is hereby incorporated herein by reference.

### TECHNICAL FIELD

The present disclosure relates to the field of laser processing systems.

### BACKGROUND

Laser processing systems adapted to process a surface of an object are known from practice. For precise processing with respect to already existing features of the object, a detection device for detecting the existing features and a laser device for processing the object are positioned and aligned with high accuracy.

### SUMMARY

A positioning of several interacting components with respect to a fixed point has the disadvantage that the positioning errors of the individual components add up.

Given the situation described above, there may be a need for a technique that allows precise processing of a workpiece while substantially avoiding one or more of the problems indicated above.

This need may be met by the independent claims. Some advantageous embodiments are indicated in the dependent claims.

In accordance with a first aspect of the subject matter disclosed herein, a method is provided.

According to an embodiment of the first aspect, a method is provided, the method comprising: processing a workpiece in a processing position and thereby generating a marking in the processing position, wherein the processing position is defined by coordinates in a processing coordinate system; determining a measuring position of the marking in a measuring coordinate system by measuring the marking; defining a mapping (image, reproduction) using the processing position and the measuring position, wherein the mapping maps a position in the measuring coordinate system onto a position in the processing coordinate system.

In accordance with a second aspect of the subject matter disclosed herein, a further method is provided.

According to an embodiment of the second aspect, a method is provided, the method comprising: determining a measuring position on a workpiece in a measuring coordinate system; determining a processing position in a processing coordinate system using the measuring position and a mapping that maps a position in the measuring coordinate system onto a position in the processing coordinate system; and processing the workpiece in the processing position.

In accordance with a third aspect of the subject matter disclosed herein, a computer program product is provided.

According to an embodiment of the third aspect, a computer program product is provided, the computer program product comprising a program element configured to, when executed on a processing device, control a method according to at least one embodiment of the first aspect and/or at least one embodiment of the second aspect.

In accordance with a fourth aspect of the subject matter disclosed herein, a processing device is provided.

According to an embodiment of the fourth aspect, a processing device is provided, the processing device comprising: a laser device configured to emit a laser beam onto a workpiece for processing the workpiece in (at) a processing position and thereby generating a marking in (at) the processing position, wherein the processing position is defined by coordinates in a processing coordinate system; a sensor device configured to determine a measuring position of the marking in a measuring coordinate system by measuring the marking; a control device configured to define a mapping using the processing position and the measuring position, wherein the mapping maps a position in the measuring coordinate system onto a position in the processing coordinate system.

Although certain disadvantages of prior technologies are mentioned herein, the present disclosure is not intended to be limited to implementations that address some or all of the mentioned disadvantages of the prior technologies. Further, although certain advantages of the subject matter disclosed herein are mentioned or implied in the present disclosure, the present disclosure is not intended to be limited to implementations that address some or all of those advantages.

### DESCRIPTION OF EXEMPLARY EMBODIMENTS

According to an embodiment, the method according to the first aspect comprises processing a workpiece in a processing position and thereby generating a marking in the processing position. According to a further embodiment, the processing position is defined by coordinates in a processing coordinate system. According to a further embodiment, the method comprises determining a measuring position of the marking in a measuring coordinate system, for example by measuring the marking. The measuring of the marking may be performed, for example, by detecting the marking in the measuring coordinate system. For example, the detecting is performed by a detection device that provides the coordinates of the marking in the measuring coordinate system. According to an embodiment, the method comprises defining a mapping using the processing position and the measuring position, wherein the mapping maps a position in the measuring coordinate system onto a position in the processing coordinate system. In an embodiment in which the method defines the mapping, the method according to the first aspect may also be referred to as a calibration method or a method comprising a calibration.

A mapping within the meaning of the present disclosure is any mapping that associates a position in the measuring coordinate system with a corresponding position in the processing coordinate system. The mapping may be implemented, for example, by a function (for example, a function approximated by curve fitting), a look-up table, an interpolation, or a combination of two or more of the foregoing. However, other implementations of the mapping are equally possible.

According to an embodiment, the method according to the second aspect comprises determining a measuring position on a workpiece in a measuring coordinate system. Determining the measuring position may be performed, for example, by detecting a (second) feature in the measuring coordinate system.

According to a further embodiment, the method comprises determining a processing position in a processing coordinate system using the measuring position and a mapping, wherein the mapping maps a position in the measuring coordinate system onto a position in the processing coordinate system. In particular, the mapping maps the measuring position to the processing position in the processing coordinate system. Further, according to an embodiment, the method comprises processing the workpiece in the processing position. In an embodiment, in which the method uses the mapping to determine a processing position, the method may also be referred to as a correction method or a method comprising a correction.

In this way, it is no longer necessary to align components of a processing device with each other with high accuracy (for example, in the micrometer range), since the process of detection and processing is not operated via absolute accuracy, but via repeat accuracy. The determination of features (for example, structure recognition) and a laser processing may be implemented by different components, and high accuracy may be achieved even when the determination of features and the processing are performed on different sides of a workpiece. Furthermore, dynamic errors may be compensated, since the calibration is not performed in a punctual standstill, but in the process environment. Image distortions, axis errors, etc. may also be at least partially compensated.

According to an embodiment of the third aspect, the computer program product comprises a program element configured to, when executed on a processing device, control a method according to at least one embodiment of the first aspect.

According to a further embodiment of the third aspect, the computer program product comprises a program element configured to, when executed on a processing device, control a method according to at least one embodiment of the second aspect.

According to an embodiment of the fourth aspect, a processing device comprises a laser device configured to emit a laser beam onto a workpiece for processing the workpiece at a processing position. According to an embodiment, the laser beam generates a marking at the processing position. According to a further embodiment, the processing position is defined by coordinates in a processing coordinate system. According to a further embodiment, the processing device comprises a sensor device, for example a sensor device configured to determine a measuring position of the marking in a measuring coordinate system by measuring the marking, for example by detecting the marking in the measuring coordinate system. For example, the sensor device may operate in the measuring coordinate system (i.e., the sensor device provides coordinates of the marking in the measuring coordinate system). According to a further embodiment, the processing device comprises a control device configured to define a mapping using the processing position and the measuring position, wherein the mapping maps a position in the measuring coordinate system onto a position in the processing coordinate system.

According to an embodiment, a processing of a workpiece requires an identifying of a processing position on the workpiece and a subsequent processing of the workpiece in the processing position.

When processing a workpiece, several errors may be included in the accuracy that may ultimately be achieved. These may be, for example, telecentricity, axis inclination, axis tilting, axis yawing, errors in the measuring system, errors in position control, etc. Furthermore, these errors may occur, at least in part, both in determining the position of the workpiece (or the processing position) and in positioning the laser beam.

At least some of the aspects and embodiments of the subject matter disclosed herein are based on the idea that a positioning accuracy of a laser beam with respect to the workpiece may be improved if a repeat accuracy is used instead of an absolute positioning accuracy with respect to a fixed point. In other words, the accuracy of processing the workpiece with respect to an existing marking is determined not by the accuracy of the absolute position of the laser device and the sensor device, but by the achievable accuracy of a positioning of the laser device and the sensor device relative to each other.

In other words, according to an embodiment, a spatial “calibration” of a sensor device and a laser device (processing device) is not performed by exact positioning of the sensor device and the laser device in a common coordinate system, but by using two coordinate systems (the measuring coordinate system and the processing coordinate system) and a mapping which maps the measuring coordinate system of the sensor device onto the processing coordinate system of the laser device and thus assigns a position in the measuring coordinate system of the sensor device to a corresponding position in the processing coordinate system of the laser device.

According to an embodiment, measuring the marking may include, for example, detecting the marking, such as with an optical system. For example, an optical system may comprise an image sensor for generating sensor data representing an image of the marking.

According to an embodiment, the measuring position is a first measuring position and the processing position is a first processing position, the method further comprising: determining a reference position in the measuring coordinate system by measuring a second marking; determining a second processing position in the processing coordinate system using the reference position and the mapping; and processing the workpiece in the second processing position. For example, the foregoing embodiment enables a calibration (i.e., the generating the mapping) using the first measuring position and the first processing position, and, using the mapping, a correction in determining the second processing position.

According to a further embodiment, determining the second processing position comprises: determining a target position in the measuring coordinate system based on the reference position, wherein the target position is defined by a predetermined spatial relationship to the reference position; determining the second processing position by mapping the target position using the mapping. For example, the target position may have a predetermined location in the measuring coordinate system with respect to the second marking. According to an embodiment, the corresponding second processing position is determined by mapping the target position using the mapping. As a result, the workpiece has the second marking and the processing (for example, a third marking) in the second processing position, wherein the processing (for example, the third marking) in the second processing position has the predetermined spatial relationship to the second marking.

According to a further embodiment, determining the second processing position comprises: determining a mapped reference position in the processing coordinate system by mapping the reference position using the mapping; determining the second processing position based on the mapped reference position, wherein the second processing position is defined by a predetermined spatial relationship to the mapped reference position. As a result, the workpiece has the second marking and the processing in the second processing position, wherein the processing in the second processing position has the predetermined spatial relationship to the second marking.

According to an embodiment, the workpiece is a first workpiece, wherein the second marking is arranged on a further, second workpiece; and wherein the second processing position is arranged on the second workpiece. In other words, according to an embodiment, the mapping may be defined using a first workpiece (by generating the marking in the processing position and determining the measuring position of the marking), while the second marking and the processing in the second processing position are arranged (or generated) on a second workpiece. For example, the mapping may be determined separately, such as in a separate calibration process and using a first workpiece that is used exclusively to define the mapping. In other words, according to an embodiment, a separate workpiece is used to generate (define) the mapping. According to a further embodiment, the workpiece to be processed (i.e., the workpiece by processing in the second processing position) may be used to generate the mapping.

According to an embodiment, the workpiece is a transparent workpiece, for example made of glass. According to a further embodiment, the workpiece is a workpiece having a first main surface and a second main surface facing away from the first main surface. For example, according to an embodiment, the workpiece is a glass plate, for example a coated glass plate, in which a coating is removed by the laser processing. In this way, for example, the coating may be structured. According to an embodiment, the workpiece is a solar module.

According to a further embodiment, determining (for example, determining the measuring position, determining the first measuring position, and/or determining the reference position) is performed on at least one of the first main surface and the second main surface, and processing (for example, processing the workpiece in the processing position, processing the workpiece in the first processing position, and/or processing the workpiece in the second processing position) is performed on at least one of the first main surface and the second main surface. For example, according to an embodiment, determining is performed on the first main surface and processing is performed on the first main surface. In other words, according to an embodiment, determining and processing are performed on the same main surface of the workpiece.

According to a further embodiment, determining is performed on the first main surface and processing is performed on the second main surface. In other words, according to an embodiment, determining and processing is performed on different main surfaces of the workpiece.

According to a further embodiment, the control device of the processing device comprises a computer program product according to embodiments of the subject matter disclosed herein. For example, according to an embodiment, the control device comprises a data memory in which a program element according to embodiments of the subject matter disclosed herein is stored. According to a further embodiment, the control device comprises a processor device configured to execute the program element and thereby control a method according to at least one embodiment of the subject matter disclosed herein (i.e., according to at least one embodiment of the present disclosure).

According to a further embodiment, the processing device comprises a workpiece receptacle for receiving (accommodating) the workpiece, wherein the workpiece has a first main surface and a second main surface, and wherein the second main surface faces away from the first main surface; wherein the sensor device faces the first main surface; and wherein the laser device is configured for processing at least one of the first main surface and the second main surface. For example, the laser device may be configured to process the second main surface so that the measuring and the processing are performed from different main surfaces of the workpiece.

According to embodiments of the first aspect, the method is adapted to provide the functionality of one or more of the embodiments disclosed herein and/or to provide the functionality as required for one or more of the embodiments disclosed herein, in particular the embodiments of the first aspect, the second aspect, the third aspect, and/or the fourth aspect.

According to embodiments of the second aspect, the method is adapted to provide the functionality of one or more of the embodiments disclosed herein and/or to provide the functionality as required for one or more of the embodiments disclosed herein, in particular the embodiments of the first aspect, the second aspect, the third aspect, and/or the fourth aspect.

According to embodiments of the third aspect, the computer program product is adapted to provide the functionality of one or more of the embodiments disclosed herein and/or to provide the functionality as required for one or more of the embodiments disclosed herein, in particular the embodiments of the first aspect, the second aspect, the third aspect, and/or the fourth aspect.

According to embodiments of the fourth aspect, the processing device is adapted to provide the functionality of one or more of the embodiments disclosed herein and/or to provide the functionality as required for one or more of the embodiments disclosed herein, in particular the embodiments of the first aspect, the second aspect, the third aspect, and/or the fourth aspect.

According to an embodiment, the program element is a non-transient program element, According to a further embodiment, the computer program product is a non-transient computer program product.

As used herein, reference to a computer program product comprising a program element is considered equivalent to reference to a computer program comprising a program element and/or a computer readable medium comprising a program element. According to an embodiment, the program element comprises instructions for controlling a processing device (comprising one or more microprocessors, for example a computer system) to effect and/or coordinate the execution of at least one method described herein.

The program element may be implemented as computer-readable instruction code using any suitable programming language, such as JAVA, C #, Python, etc., and may be stored on a computer-readable medium (removable disk, volatile or non-volatile memory, embedded memory/processor, etc.). According to an embodiment, the instruction code is executable for programming a computer or any other programmable processing device to perform the intended functions. The computer program may be available on a network, such as the World Wide Web, from which it may be downloaded, for example.

The subject matter disclosed herein may be realized by means of a computer program product (program element), respectively software. However, the subject matter disclosed herein may also be realized by one or more specific electronic circuits, respectively hardware. Further, the subject matter disclosed herein may also be realized in hybrid form, i.e., in a combination of software modules and hardware modules.

Exemplary embodiments of the subject matter disclosed herein are described below, referring, for example, to various methods, a computer program product, and a processing device. It should be emphasized that, of course, any combination of features of various aspects, embodiments and examples is possible. In particular, some embodiments are described with reference to a method, while other embodiments are described with reference to an apparatus. Still other embodiments are described with reference to a control device for interacting with further elements of the processing device. However, it will be understood by those skilled in the art from the foregoing and subsequent description, claims, and drawings that, unless otherwise indicated, features of various aspects, embodiments, and examples may be combined, and such combinations of features are to be considered disclosed by this application. For example, even a feature relating to a method is combinable with a feature relating to an apparatus, and vice versa.

According to an embodiment, a method disclosed herein may define the functionality of a device disclosed herein without being limited to the device-specific features. In this respect, any functionality of a device disclosed herein is intended to implicitly disclose a corresponding method defined exclusively by the disclosed functionality. Conversely, according to an embodiment, a method disclosed herein may be carried out using any suitable known device (which may have a single element or multiple cooperating elements). In this respect, any method disclosed herein is intended to implicitly disclose a corresponding device configured to perform the method.

Further advantages and features of the present disclosure will be apparent from the following exemplary description of presently preferred embodiments, to which, however, the present disclosure is not limited. The individual figures of the drawings of this document are to be considered merely schematic and not to scale.

### BRIEF DESCRIPTION OF THE DRAWINGS

FIG. 1 illustrates a processing device 100 in accordance with embodiments of the subject matter disclosed herein.

FIG. 2 illustrates a further processing device 200 in accordance with embodiments of the subject matter disclosed herein.

FIG. 3 illustrates the mapping between the measuring coordinate system 112 and the processing coordinate system 118.

FIG. 4 illustrates a processing device 300 in accordance with embodiments of the subject matter disclosed herein.

### DETAILED DESCRIPTION

It is noted that in different figures similar or identical elements or components are provided with the same reference numerals, or with reference numerals differing only in the first digit. Such features or components that are identical or at least functionally identical to the corresponding features or components in another figure are described in detail only on their first occurrence in the following text, and the description is not repeated on subsequent occurrences of these features and components (or the corresponding reference numerals).

It is understood that the elements described below and marked with reference signs are shown in the relevant drawings and configured according to the following description, unless otherwise indicated.

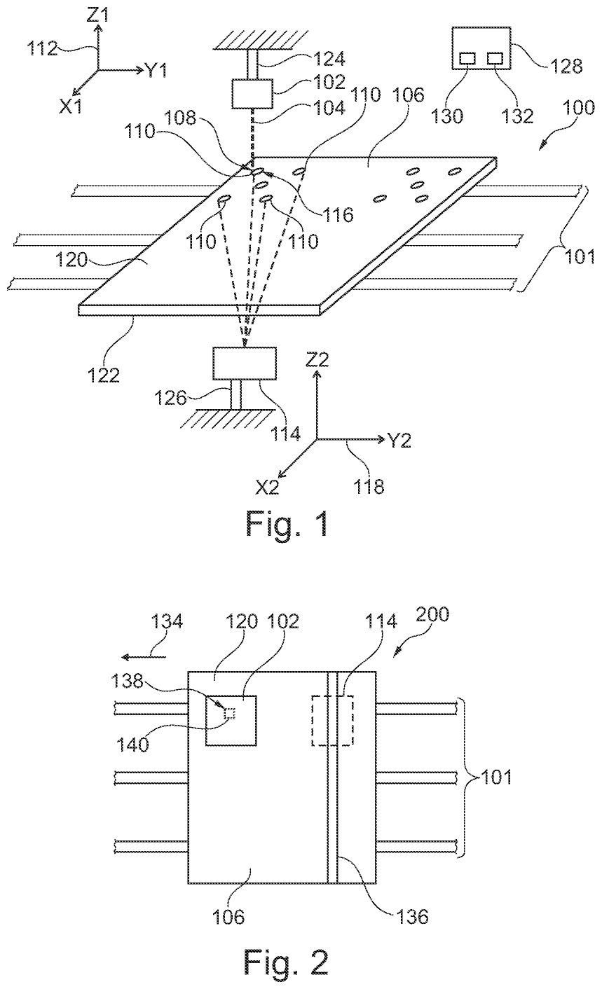

FIG. 1 illustrates a processing device 100 in accordance with embodiments of the subject matter disclosed herein.

According to an embodiment, the processing device 100 comprises a workpiece receptacle 101 configured to receive a workpiece 106, According to an embodiment, the workpiece receptacle 101 may also be configured to transport the workpiece 106.

According to an embodiment, the processing device 100 comprises a laser device 102 configured to emit a laser beam 104 onto the workpiece 106. The laser beam 104 processes the workpiece 106 in at least one processing position 108, thereby generating a marking 110 in the processing position 108. According to an embodiment, the processing device 100 is configured to process the workpiece in a plurality of processing positions 108, thereby generating a plurality of markings 110, for example as shown in FIG. 1.

The laser device 102 operates in a processing coordinate system 112. In other words, when the laser device 102 is given coordinates X1, Y1, Z1 for a processing position 108, the workpiece 106 is processed in a position represented in the processing coordinate system 112 by these same coordinates X1, Y1, Z1.

According to a further embodiment, the processing device 100 comprises a sensor device 114 configured to determine a measuring position 116 of the marking 110 in a measuring coordinate system 118 by detecting the marking 110. Detecting the marking 110 with the sensor device 114 provides corresponding coordinates X2, Y2, Z2 of the marking 110 in the measuring coordinate system 118.

According to an embodiment, the laser device 102 faces a first main surface 120 of the workpiece 106 and the sensor device 114 faces a second main surface 122 of the workpiece, the second main surface 122 facing away from the first main surface 120, for example as shown in FIG. 1. For example, the laser device 102 is mounted on a first support device 124 and the sensor device 114 is mounted on a second support device 126. A support device 124, 126 may be, for example, an axis system having at least one axis about which the respective device 102, 114 is movable, for example, linearly displaceable or rotatable.

Since, according to an embodiment described, the laser device 102 and the sensor device 114 are mounted on different support devices, the two devices 102, 114 are not precisely aligned with each other, but only within an absolute positioning accuracy, with errors in positioning and alignment adding up. In other words, in general, the processing coordinate system 112 and the measuring coordinate system 118 are different from each other. However, the processing device 100 is subject not only to the positioning errors of the laser device 102 and the sensor device 114, but also to other errors, axis tilt, axis tilting, axis yaw, position control errors, and so forth. In particular, the sensor device 114 may further be subject to telocentric errors, measurement system errors, etc.

Calibration in accordance with embodiments of the subject matter disclosed herein may at least partially eliminate (i.e., reduce or (completely) eliminate) the foregoing errors, in particular if the errors are systematic errors (i.e., errors that do not change from measurement to measurement or from processing to processing).

To this end, according to an embodiment, the laser device 102 comprises a control device 128 configured to define a mapping using the processing position 108 and the measuring position 116, wherein the mapping maps a position in the measuring coordinate system 118 onto a position in the processing coordinate system 112. This mapping may be stored in a memory device 130 of the control device 128. According to a further embodiment, the control device 128 comprises a processing device 132 configured to execute a program element of a computer program product according to embodiments of the subject matter disclosed herein. For example, the program element may be stored in the memory device 130 or in a further memory device.

According to an embodiment, the purpose of generating the marking 110 is to calibrate or define the mapping. Such marking 110 is also referred to herein as the first marking.

The mapping may then be used to reduce or eliminate errors in a processing process in which an already existing marking on a workpiece is detected and the workpiece is to be marked in a position that has a predetermined spatial relationship to the existing marking. Such a processing process is described below with reference to FIG. 2.

FIG. 2 shows a top view of a further processing device 200 in accordance with embodiments of the subject matter disclosed herein.

According to an embodiment, the sensor device 104 is arranged in a direction 134 spaced apart from the laser device 102. According to an embodiment, the direction 134 is arranged parallel to the main surface 120.

According to an embodiment, a marking 136 (also referred to herein as a second marking) already existing on the workpiece 106 is sensed in a processing process. According to an embodiment, sensing a marking (for example, the marking 136) is sensing a position of the marking.

According to an embodiment, a reference position in the measuring coordinate system is determined by sensing the second marking. For example, a sensed position of the marking is used as the reference position.

According to an embodiment, a target position in the measuring coordinate system is determined based on the reference position. Here, the target position is defined by a predetermined spatial relationship with respect to the reference position. The predetermined spatial relationship may be stored, for example, in the memory device 130 of the control device 128 (see FIG. 1). In order for the spatial relationship between the second marking 136 and a desired second processing position 138 to most closely approximate the predetermined spatial relationship between the reference position and the target position (both defined in the measuring coordinate system), the second processing position is determined by mapping the target position using the mapping. The term “most closely approximate” was used because any real positioning and processing is subject to certain tolerances, and thus an ideal computational spatial relationship is not usually achieved in practice.

It is understood that instead of mapping the target position from the measuring coordinate system to the processing coordinate system using the mapping, the reference position may alternatively be mapped from the measuring coordinate system to the processing coordinate system using the mapping, and then the second processing position 138 is determined based on the mapped reference position so that the second processing position has the predetermined spatial relationship to the mapped reference position.

Subsequently, the workpiece 106 may be processed in the second processing position 138 using the laser device 102 to generate a further marking 140 (also referred to herein as a third marking) on the workpiece 106,

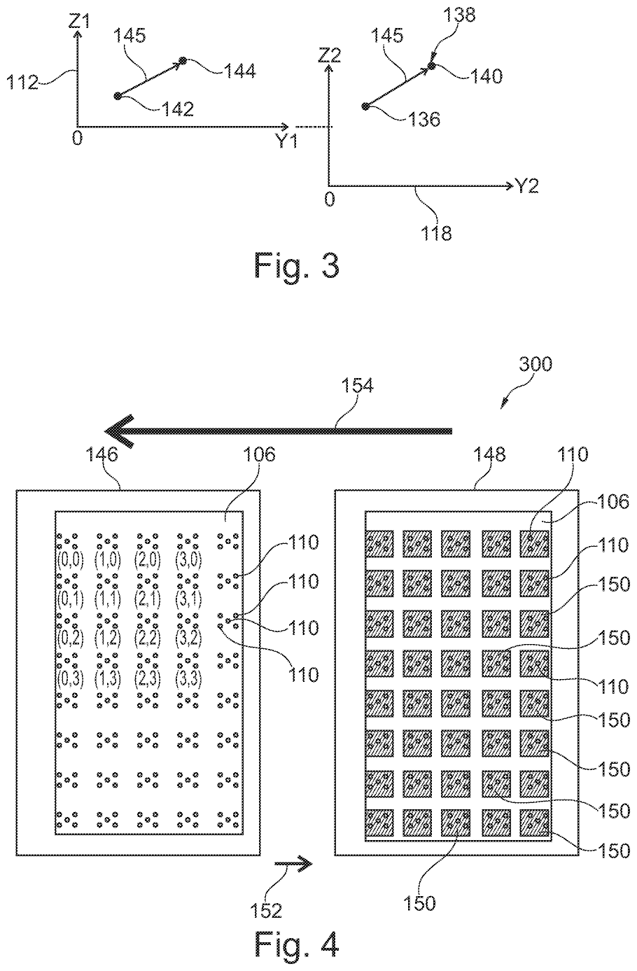

FIG. 3 illustrates the mapping between the measuring coordinate system 112 and the processing coordinate system 118. For simplicity of presentation, the coordinate systems 112, 118 are shown in two dimensions only (Y-Z plane).

According to an embodiment, the measuring coordinate system 112 is linearly displaced with respect to the processing coordinate system 118, for example along the Z2 axis, for example as exemplarily shown in FIG. 3. In this way, the Z value of the second marking 136 in the processing coordinate system differs from the Z value of the reference position 142 in the measuring coordinate system. Therefore, in order to achieve the correct spatial relationship between the second marking 136 and the desired third marking 140 based on the measurement (sensing the position of the second marking 136, which provides the coordinates of the reference position 142 in the measuring coordinate system), according to an embodiment, the target position 144 is determined in the measuring coordinate system and this target position 144 is subsequently mapped by the mapping into the processing coordinate system 118, thereby obtaining the second processing position 138 which, when processed by the laser device 102, results in the desired third marking 140. The predetermined spatial relationship is represented in both coordinate systems 112, 118 by vector 145.

It is understood that a linear displacement along a single axis is a simplification used to explain principles of the present disclosure. In general, the measuring coordinate system 112 and the processing coordinate system 118 may be arbitrarily positioned relative to each other, for example, displaced in 2 or 3 spatial directions.

FIG. 4 illustrates a processing device 300 in accordance with embodiments of the subject matter disclosed herein.

According to an embodiment, the processing device 300 comprises a laser station 146 in which the laser device is arranged for processing the workpiece 106. Further according to an embodiment, the processing device 300 comprises a detection station 148 in which the sensor device is arranged (not shown in FIG. 4) for sensing the workpiece 106. According to an embodiment, the sensor device comprises a plurality of sensor elements, for example camera systems. Some of the fields of view of the individual camera systems are designated 150 in FIG. 4.

According to an embodiment, at least two markings 110 are generated in the workpiece 106 to generate the mapping in at least one field of view of a camera system. In this way, the camera field of view may be measured. For example, a plurality of markings 110 are generated in the workpiece 106 in each field of view of a camera system. In FIG. 4, only some of the markings are provided with the reference number 110.

As described with reference to FIG. 1, to generate the mapping, at least one (first) marking 110 is first generated in the workpiece, for example in the laser station 146. According to an embodiment, the workpiece 106 is then transported to the detection station 148, in which a measuring position of each marking is determined by measuring the marking using the associated sensor element (for example, the associated camera system).

According to an embodiment, consequently, to generate the mapping, a transport direction 152 of the workpiece 106 is opposite to the usual transport direction 154 during a processing process in which first a second marking already present on the workpiece is measured and then a third marking is introduced into the workpiece 106 with the laser device in the laser station 146.

According to an embodiment, the first marking used to define the mapping is generated in the same workpiece on which the processing process (the generation of at least a third marking) is to be performed. According to a further embodiment, the first marking used to define the mapping may be generated and measured in a separate workpiece.

It should be noted that a laser device or a sensor device as described herein is not limited to the decided entities as described in some embodiments. Rather, the entities disclosed herein may be implemented in numerous ways while still providing the disclosed specific functionality.

According to embodiments of the subject matter disclosed herein, any suitable entity (e.g., components, elements, units, devices, and stations) may be provided at least in part in the form of respective computer programs that enable a processing device to provide the functionality of the corresponding entity as described herein. According to other embodiments, any suitable entity as described herein may be provided in hardware. According to other, hybrid embodiments, some entities may be provided in software while other entities are provided in hardware.

It is noted that each entity disclosed herein is not limited to a decided entity as described in some embodiments. Rather, the subject matter described herein may be provided in different ways with different granularity at the device level or at the software module level while still providing the specified functionality. Further, it should be noted that according to embodiments, a separate entity (e.g., a software module, a hardware module, or a hybrid module) may be provided for each of the functions disclosed herein. According to other embodiments, one entity (e.g., a software module, in hardware module, or a hybrid module) may be configured to provide two or more functions as described herein. According to yet other embodiments, two or more entities (e.g., components, units, and devices) may be configured to collectively provide a function as described herein.

According to an embodiment, the control device includes a processor device comprising at least one processor for executing at least one program element, which may correspond to a corresponding software module.

A reference to a laser beam may of course also be defined analogously with reference to a radiation path of the laser radiation, and vice versa. In this respect, any reference to a laser beam discloses analogously a reference to a radiation path of the laser radiation.

It should be noted that the embodiments described herein represent only a limited selection of possible embodiments of the present disclosure. Thus, it is possible to combine the features of different embodiments in a suitable manner, so that for those skilled in the art, a plurality of combinations of different embodiments are to be considered disclosed with the embodiments explicitly disclosed herein. Furthermore, it should be mentioned that terms such as “a” or “an” do not exclude a plurality. Terms such as “comprising” or “having” do not exclude further features or process steps. Consequently, according to an embodiment, the term “comprising” or “having” stands for “comprising, among other things”. According to a further embodiment, the term “comprising” or “having” stands for “consisting of”. According to an embodiment, the term “adapted to” includes, but is not limited to, the meaning “configured to”.

It should also be noted that reference signs in the claims should not be construed as limiting the scope of the claims. It should also be noted that reference signs in the description and the description's reference to the drawings should not be construed as limiting the scope of the description. Rather, the drawings illustrate only an exemplary implementation of a determined combination of several embodiments of the subject matter disclosed herein, any other combination of embodiments being equally possible and to be considered disclosed with this application.

In summary, it remains to be stated:

Disclosed is a method comprising: processing a workpiece in a processing position and thereby generating a marking in the processing position, wherein the processing position is defined by coordinates in a processing coordinate system; determining a measuring position of the marking in a measuring coordinate system by measuring the marking; defining a mapping using the processing position and the measuring position, wherein the mapping maps a position in the measuring coordinate system onto a position in the processing coordinate system.

1.-10. (canceled)

11. A method comprising:
processing a workpiece in a processing position and thereby generating a marking in the processing position, wherein the processing position is defined by coordinates in a processing coordinate system;
determining a measuring position of the marking in a measuring coordinate system by measuring the marking;
defining a mapping using the processing position and the measuring position, wherein the mapping maps a position in the measuring coordinate system onto a position in the processing coordinate system.

12. The method of claim 11, wherein the measuring position is a first measuring position and the processing position is a first processing position, the method further comprising:
determining a reference position in the measuring coordinate system by measuring a second marking;
determining a second processing position in the processing coordinate system using the reference position and the mapping;
processing the workpiece in the second processing position.

13. The method of claim 12, wherein determining the second processing position comprises:
determining a target position in the measuring coordinate system based on the reference position, wherein the target position is defined by a predetermined spatial relationship with respect to the reference position;
determining the second processing position by mapping the target position using the mapping.

14. The method of claim 12, wherein determining the second processing position comprises:
determining a mapped reference position in the processing coordinate system by mapping the reference position using the mapping;
determining the second processing position based on the mapped reference position, wherein the second processing position is defined by a predetermined spatial relationship with respect to the mapped reference position.

15. The method according to claim 12,
wherein the workpiece is a first workpiece;
wherein the second marking is arranged on a further, second workpiece; and
wherein the second processing position is arranged on the second workpiece.

16. A method comprising:
determining a measuring position on a workpiece in a measuring coordinate system;
determining a processing position in a processing coordinate system using the measuring position and a mapping that maps a position in the measuring coordinate system onto a position in the processing coordinate system;
processing the workpiece in the processing position.

17. The method according to claim 11, wherein
the workpiece is a transparent workpiece having a first main surface and a second main surface facing away from the first main surface; and/or
determining is performed on at least one of the first main surface and the second main surface, and processing is performed on at least one of the first main surface and the second main surface.

18. The method according to claim 16, wherein
the workpiece is a transparent workpiece having a first main surface and a second main surface facing away from the first main surface; and/or
determining is performed on at least one of the first main surface and the second main surface, and processing is performed on at least one of the first main surface and the second main surface.

19. A processing device comprising:
a laser device configured to emit a laser beam onto a workpiece to process the workpiece in a processing position and thereby generating a marking in the processing position, wherein the processing position is defined by coordinates in a processing coordinate system;
a sensor device configured to determine a measuring position of the marking n a measuring coordinate system by measuring the marking;
a control device configured to define a mapping using the processing position and the measuring position, wherein the mapping maps a position in the measuring coordinate system onto a position in the processing coordinate system.

20. The processing device according to claim 19, further comprising:
a workpiece receptacle for receiving the workpiece, the workpiece having a first main surface and a second main surface, the second main surface facing away from the first main surface:
wherein the sensor device faces the first main surface; and
wherein the laser device faces at least one of the first main surface and the second main surface.
